(19) United States
(12) Patent Application Publication
(10) Pub. No.: US 2007/0136757 A1
(43) Pub. Date: Jun. 14, 2007

(54) System and method for a content-centric electronic guide

(75) Inventors: Christopher Cormack, Hillsboro, OR (US); Tony Moy, Beaverton, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/298,266

(22) Filed: Dec. 9, 2005

(51) Int. Cl. H04N 5/445; G06F 13/00

(52) U.S. Cl. 725/47; 725/45; 725/44; 725/46

(57) ABSTRACT

A system and method for a content-centric electronic guide. The method may include receiving content and related guide data at a device, receiving an indication of favorite content of one or more viewers at the device and generating, by the device, a content-centric electronic guide based on the content, the related guide data and the indication of favorite content.

### BACKGROUND

Standard electronic program guides (EPGs) provide a program listing based on the channel, for given time slots. This is typically a huge list that the viewer must manually search through to find his or her favorite programs. Finding specific programs can be quite difficult as the viewer must scroll down and to the right of the EPG for long periods of time and often through multiple screens of information.

### BRIEF DESCRIPTION OF THE DRAWINGS

The invention may be best understood by referring to the following description and accompanying drawings that are used to illustrate embodiments of the invention. In the drawings:

FIG. 1 illustrates an example of a standard electronic programming guide (EPG);

FIG. 2 illustrates an example of a content-centric electronic guide, according to an embodiment of the invention;

FIG. 3 illustrates an example of a content-centric electronic guide, according to an embodiment of the invention;

FIG. 4 illustrates an embodiment of an environment for the content-centric electronic guide, in which some embodiments of the present invention may operate;

FIG. 5 illustrates an embodiment of an environment for the content-centric electronic guide, in which some embodiments of the present invention may operate; and

FIG. 6 is a flow diagram of one embodiment of a process for the operation of generating a content-centric electronic guide, in which some embodiments of the present invention may operate.

### DESCRIPTION OF EMBODIMENTS

According to an embodiment of the invention, a system and method for a content-centric electronic guide are described. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

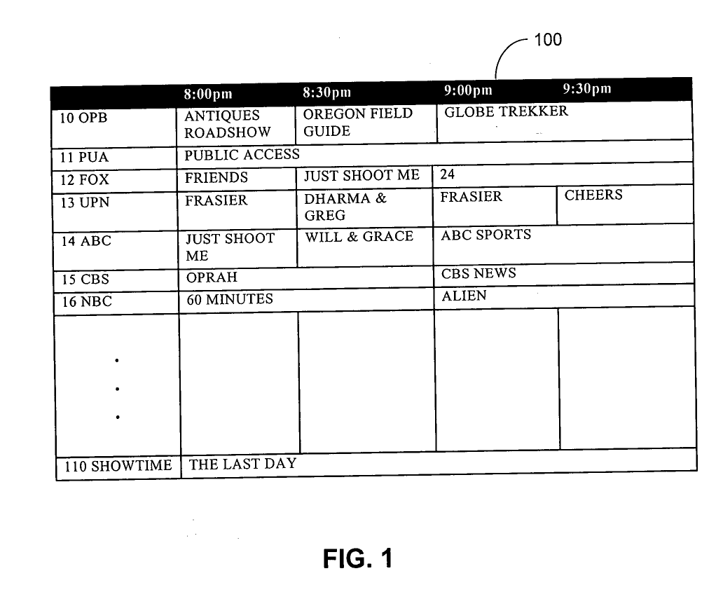

FIG. 1 illustrates an example of a standard EPG 100. Referring to FIG. 1, the standard EPG is broadcast channel oriented, for given time slots. This is typically a huge list that the viewer must manually search through to find his or her favorite shows. Finding specific shows can be quite difficult as the viewer must scroll down and to the right of the EPG for long periods of time and often through multiple screens of information.

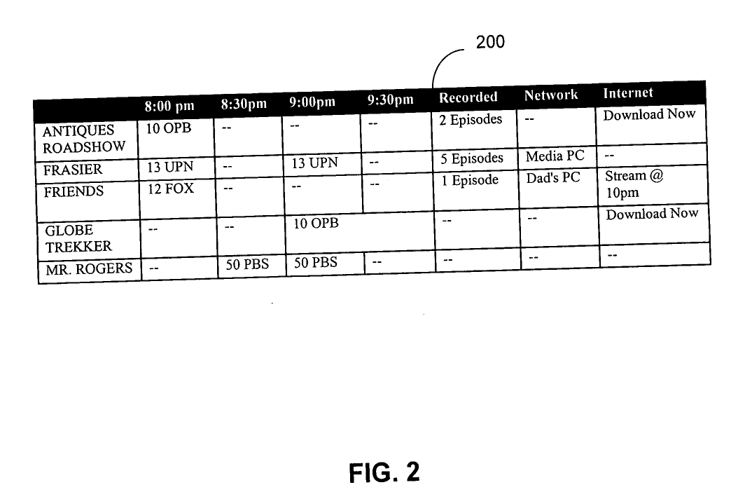

FIG. 2 illustrates an example of a content-centric electronic guide 200, according to an embodiment of the invention. In some embodiments of the invention, the content-centric electronic guide may reflect favorite content as indicated by one or more viewers. In an embodiment of the invention, content may include, but is not limited to, shows or programs, voice, audio, music, graphics, video games, books, and so forth. The content may be broadcasted, pre-recorded and stored on a digital recording device (such as a personal video recorder (PVR)), streamed or downloaded via the Internet, stored on a home local area network (LAN) (such as in a networked home entertainment system), and so forth. Viewers can see at a glance when and how favorite content is available for viewing, instead of manually searching through a regular EPG. The content of the electronic guide of the present invention may be listing alphabetically, sorted by relevance, or organized in any means that provides ease of use to a viewer.

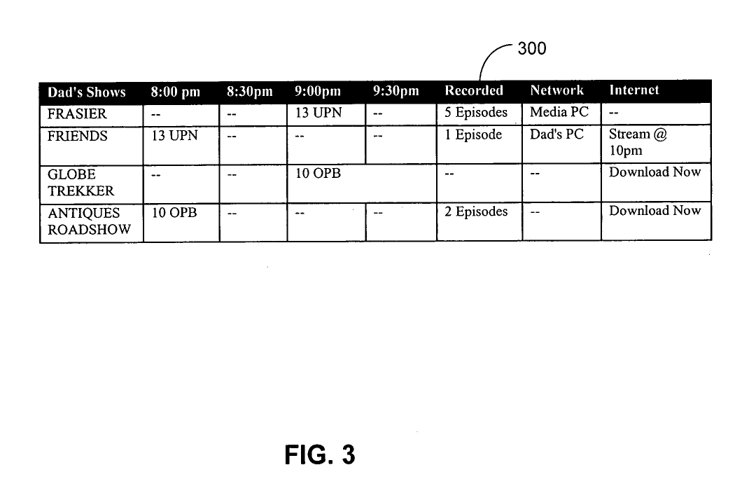

FIG. 3 illustrates an example of a content-centric electronic guide 300 that is configurable for individual members of a household, according to an embodiment of the invention. The electronic guide of FIG. 3 reflects the. favorite content of a specific viewer. For example, dad might have his set of favorite content (as illustrated in FIG. 3), mom might have her set of favorite content and one or more children may have their sets of favorite content. A user interface or remote control button may be utilized to allow easy access to a specific viewer's list of favorite content. The electronic guides of FIGS. 2 and 3 may be utilized by a viewer to select what content to watch, listen to, play, record, download, etc. The example electronic guides of FIGS. 2 and 3 are provided for illustration purposes only and are not meant to limit the invention.

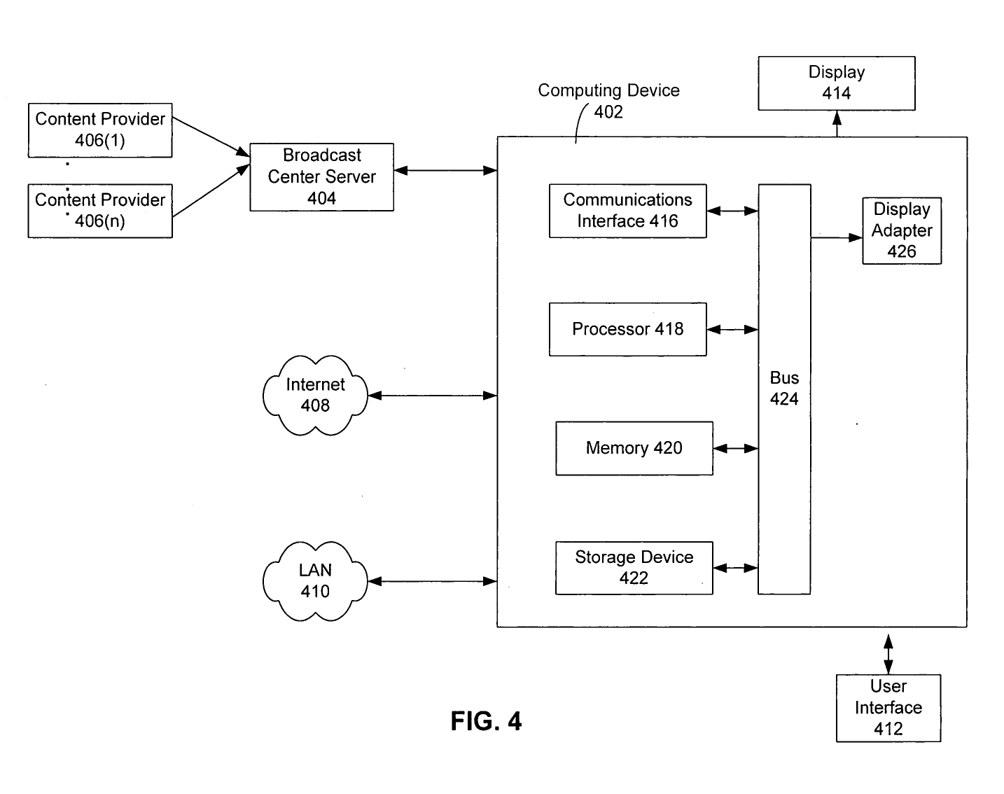

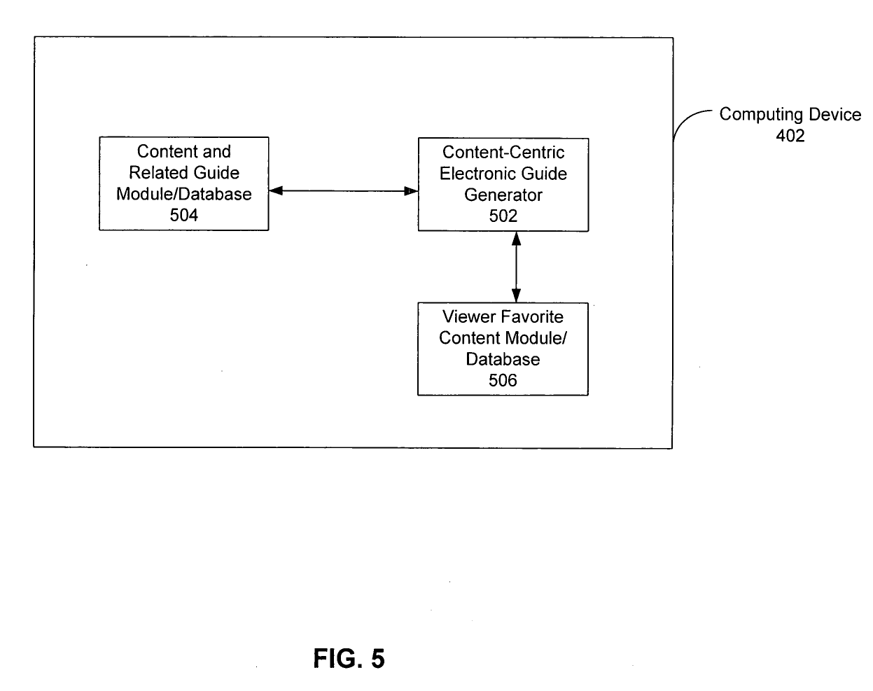

FIGS. 4 and 5 each illustrate an embodiment of an environment for the content-centric electronic guide, in which some embodiments of the present invention may operate. The specific components shown in each of FIGS. 4 and 5 represent one example of a configuration that may be suitable for the invention and is not meant to limit the invention. Thus, other embodiments of the invention may include more or less components as described in each of FIGS. 4 and 5. For example, the functionality of two or more components of FIGS. 4 or 5 may be combined into one component. Likewise, the functionality of one component of FIGS. 4 or 5 may be separated and performed by more than one component. Each component shown in FIGS. 4 or 5 may be implemented as a hardware element, as a software element executed by a processor, as a silicon chip encoded to perform its functionality described herein, or any combination thereof.

The environments of each of FIGS. 4 and 5 may be implemented as a wired communication system, a wireless communication system, or a combination of both. Although the environment of each of FIGS. 4 and 5 may be illustrated using a particular communications medium by way of example, it may be appreciated that the principles and techniques discussed herein may be implemented using any type of communication media and accompanying technology. The embodiments are not limited in this context. Other communication systems may be added or substituted according to the particular application for the environment in FIGS. 4 and 5 and/or as new types of systems are developed.

Referring to FIG. 4, the environment may include, but is not necessarily limited to, a computing device 402, a broadcast center server 404, one or more content providers 406(1)-406(n), the Internet 408, a local area network (LAN) 410, a user interface 412 and a display 414. Computing device 402 may include, but is not limited to, a communications interface 416, a processor 418, memory 420, a storage device 422, a bus 424 and a display adapter 426. At a high level and in an embodiment of the invention, computing device 402 may receive content and related guide data for a content-centric electronic guide from broadcast center server 404, the Internet 408, LAN 410 and from content stored on computing device 402 itself. Computing device 402 may also receive input via user interface 412 from one or more viewers regarding favorite content, activation and/or reconfiguration of the content-centric electronic guide, and so forth. The content-centric electronic guide may be displayed on display 414.

In an embodiment of the invention, content may include, but is not necessarily limited to, shows or programs, voice, audio, music, graphics, video games, books, and so forth. In an embodiment of the invention, related guide data may include, but is not necessarily limited to, content name, channel or location (e.g., location on the Internet 408 via an Internet Protocol (IP) address or Uniform Resource Location (URL), location on a hard disk found in LAN 410, location on computing device itself, etc.), type of content (e.g., broadcast, stream, download, etc.), metadata (e.g., content description, year of release, ratings information, category, etc.), air time, a brief synopsis, stars, and so forth. These examples are not meant to limit the invention. Each of the components of FIG. 4 is described next in more detail.

Computing device 402 may be any device adapted to include the functionality of the prevent invention. For example, device 402 may be a set-top box, a digital video recorder, a digital network recorder, a personal computer, a portable computer, a cellular telephone, a personal digital assistant (PDA), a computing tablet, or any other similar device. Although only one computing device 402 is depicted in FIG. 4, the invention may involve multiple computing devices 402.

In an embodiment of the invention, computing device 402 may include communications interface 416 that allows for the receipt of high-speed digital data such as a cable modem, DSL modem, Ethernet interface, satellite receiver, etc. Computing device 402 may also include a non-volatile storage device 422 for storing received digital data for later access. Such storage devices typically include magnetic media such as hard disk drives and may include other machine readable media such as optical disks, card and stick memory devices, flash memory devices, and the like.

In one embodiment, the invention is included in computing device 402 as software that is stored on storage device 422 or other machine readable medium and is executed by processor 418 which utilizes memory 420. Processor 418 may be any processor, and memory 420 may be any kind of random access memory (RAM) or other form of memory.

Computing device 402 may process received content and related guide data to create a content-centric electronic guide and sends a resulting signal via display adapter 426 to display 414 to be presented to a viewer. Communications interface 416, processor 418, memory 420, storage device 422 and display adapter 426 are, in one embodiment, coupled to bus 424. In various embodiments, computing device 402 may include multiple communications interfaces, processors, storage devices, display adapters and buses, as well as other components not shown in FIG. 4. In various embodiments, computing device 402 may include an audio processor and/or game processor or game interface.

In an embodiment of the invention, computing device 402 may receive content and related guide data for a content-centric electronic guide from broadcast center server 404, the Internet 408 and LAN 410. Content and related guide data used for the content-centric electronic guide may also be recorded on computing device 402 itself (e.g. in storage device 422). Broadcast center server 404 may receive data from at least one content provider 406 and forwards digital data to computing device 402. Content providers 406 may be a server computer or a group, subnetwork, LAN or other group of multiple computers, that provide data to broadcast center server 404.

The Internet 408 may be used by computing device 402 for streamed content and related guide data (such as via subscription services) and for downloadable content and related guide data (such as video/audio from an Internet-based store that allows a user to purchase video/audio). LAN 410 may be a household, office, or store media server or personal computers that contain content, such as, for example, television programs and audio files.

In embodiments of the invention, connections between content providers 406, broadcast center server 404, the Internet 408, LAN 410 and computing device 402 may be one or more of T1 lines, T3 lines, coaxial cable, Ethernet, twisted-pair, fiber optics such as a Synchronous Optical Network (SONET), digital television (DTV), cable television (CATV), microwave, satellite, radio waves, or any combination of wired/wireless communications.

In an embodiment of the invention, broadcast center server 404, the Internet 408 and LAN 410 may receive content as digital data or analog data. If analog data is received, it may be converted into an appropriate digital format before being forwarded to computing device 402. When content is received as analog data, it may be any well-known or proprietary analog format, such as the National Television System Committee (NTSC) format.

The format of the content sent to computer device 402 may be any digital data format, including, for example, data interchange formats such as Internet Protocol (IP) Packets and File Transfer Protocol (FTP) packets; combined audio and moving video formats such as the formats promulgated by the International Telecommunications Union (ITU), the Advanced Television Systems Committee (ATSC), and similar organizations such as High Definition Television (HDTV) and Moving Pictures Expert Group (MPEG); related audio formats; still video formats such as Joint Photographic Experts Group (JPEG) format, Graphic Interchange Format (GIF); and so forth.

In an embodiment of the invention, the content-centric electronic guide may be displayed on display 414. Display 414 may be external to computing device 402 or may be incorporated into device 402. Display 414 may be a cathode ray tube (CRT) display monitor, a thin film transistor (TFT) display screen, a liquid crystal display (LCD), or any display device suitable for displaying graphics and images.

User interface 412 may be any device capable of allowing one or more viewers to interface with computing device 402. User interface 412 may be external to computing device 402 or may be incorporated into device 402. For example, user interface 412 may be utilized by one or more viewers to indicate favorite content to computing device 402, to activate the content-centric electronic guide, to configure the content-centric electronic guide, and so forth. In embodiments of the invention, user interface 412 may be implemented as a remote control, a PDA, a touch screen or button(s) on the display 414 or computing device 402, a joystick, a keyboard, a game pad, a personal computer, a laptop computer, a cellular phone, and so forth. These examples are provided for illustration purposes only and are not meant to limit the invention.

FIG. 5 illustrates an embodiment of an environment for the content-centric electronic guide, in which some embodiments of the present invention may operate. Referring to FIG. 5, computing device 402 may include a content-centric electronic guide generator 502, a content and related guide module/database 504 and a viewer favorite content module/database 506. Each of these components may be implemented via software, firmware, hardware, or by any combination of various techniques. Each of these components is described next in more detail.

Content and related guide module/database 504 stores, aggregates and indexes the content and related guide data received via broadcast center server 404, the Internet 408, LAN 410 and recorded on computing device 402 itself. Viewer favorite content module/database 506 stores an indication of the viewer's favorite content. In an embodiment of the invention, the viewer's favorite content may be stored according to relevance (e.g., the most favorite content, followed by the next most favorite content, and so forth). Content-centric electronic guide generator 502 examines the content and/or related guide data from module/database 504 and an indication of the viewer's favorite content stored from module/database 506 and generates a content-centric electronic guide.

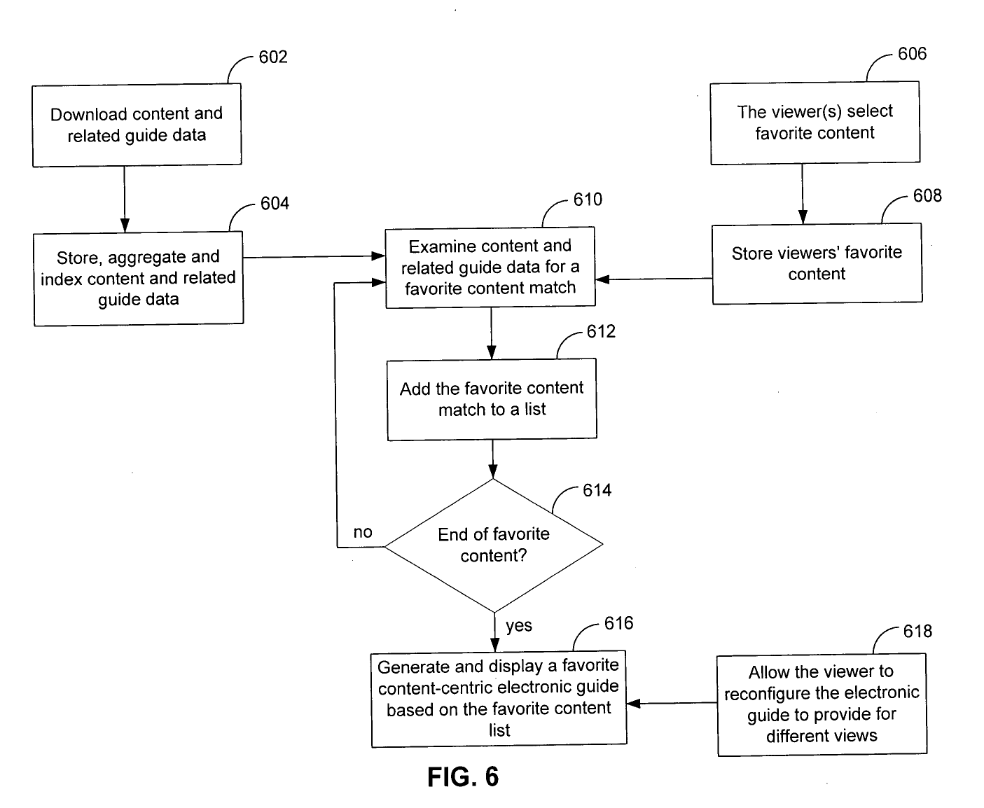

Embodiments of the operation of the present invention are described next with reference to FIG. 6. The flow diagram and other descriptions of processes herein are not intended to imply a fixed order of performing the process stages. Rather, the process stages may be performed in any order that is practicable.

FIG. 6 is a flow diagram of one embodiment of a process for the operation of generating a content-centric electronic guide, in which some embodiments of the present invention may operate. Referring to FIG. 6, the process begins at block 602 where content and related guide data are downloaded to computing device 402. At block 604, the content and related guide data are stored, aggregated and indexed via content and related guide module/database 504.

A viewer selects his or her favorite content via user interface 412, at block 606. At block 608, an indication of the viewer's favorite content is stored in viewer favorite content module/database 506.

The content, related guide data and favorite viewer content are examined via content-centric electronic guide generator 502 for a favorite content match, at block 610. For example, generator 502 starts with favorite show n and looks for a match against all channels, time slots and content locations. At block 612, the favorite content match is added to a list. If there are additional favorite content at block 614, then the content and related guide data are examined for another favorite content match (e.g., favorite content n+1), at block 610.

A favorite content-centric electronic guide is generated and displayed based on the favorite content list, at block 616. In an embodiment, the favorite content of the electronic guide is sorted and displayed alphabetically. In another embodiment, the favorite content of the electronic guide is sorted and displayed by relevance (e.g., list the most favorite content first and the next most favorite content second, and so forth). These examples are provided for illustration purposes and are not meant to limit the invention.

At block 618, the viewer may interface with the content-centric electronic guide to reconfigure it and provide a different view or format. For example, the viewer may want to switch the listings from alphabetically to favorite content relevance, from favorite content relevance to alphabetically, to remove some content listings, to switch from a listing of dad's favorite content to mom's favorite content, to view the electronic guide as a standard EPG as described in FIG. 1, and so forth. These examples are not meant to limit the invention and are provided for illustration purposes.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc-Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
generating a content-centric electronic guide based on content and related guide data.

2. The method of claim 1, further comprising: receiving the content and the related guide data at a device, wherein the device generates the content-centric electronic guide.

3. The method of claim 1, further comprising:
receiving an indication of favorite content of one or more viewers, wherein generating the content-centric electronic guide is also based on the indication of favorite content.

4. The method of claim 3, further comprising:
displaying the content-centric electronic guide, wherein the displayed content-centric electronic guide lists the favorite content by relevance based on the indication of favorite content.

5. The method of claim 3, further comprising:
displaying the content-centric electronic guide, wherein the displayed content-centric electronic guide lists the favorite content in alphabetical order.

6. The method of claim 3, further comprising:
displaying the content-centric electronic guide, wherein the displayed content-centric electronic guide lists the favorite content for a specific viewer of the one or more viewers.

7. The method of claim 1, further comprising:
displaying the content-centric electronic guide; and
allowing one or more viewers to change the format of the displayed content-centric electronic guide.

8. The method of claim 1, wherein the content and the related guide data may be received from one or more of a broadcast center server, the Internet, a local area network (LAN) and the device.

9. The method of claim 1, further comprising: receiving the content and the related guide data at a device, wherein the device generates the content-centric electronic guide and wherein the device is a set-top box.

10. A system comprising:
a device to generate a content-centric electronic guide based on content and related guide data.

11. The system of claim 10, wherein the device receives the content and the related guide data.

12. The system of claim 10, further comprising:
a user interface to allow one or more viewers to provide to the device an indication of favorite content, wherein the indication of favorite content is also used to generate the content-centric electronic guide.

13. The system of claim 12, further comprising:
a display device to display the content-centric electronic guide, wherein the displayed content-centric electronic guide lists the favorite content by relevance based on the indication of favorite content.

14. The system of claim 12, further comprising:
a display device to display the content-centric electronic guide, wherein the displayed content-centric electronic guide lists the favorite content in alphabetical order.

15. The system of claim 12, further comprising:
a display device to display the content-centric electronic guide, wherein the displayed content-centric electronic guide lists the favorite content for a specific viewer of the one or more viewers.

16. The system of claim 12, further comprising:
a display device to display the content-centric electronic guide, wherein the user interface to receive an indication from the one or more viewers to change the format of the displayed content-centric electronic guide.

17. The system of claim 10, wherein the content and the related guide data may be received from one or more of a broadcast center server, the Internet, a local area network (LAN) and the device.

18. The system of claim 10, wherein the device is a set-top box.

19. A machine-readable medium containing instructions which, when executed by a processing system, cause the processing system to perform a method, the method comprising:
generating a content-centric electronic guide based on content and related guide data.

20. The machine-readable medium of claim 19, receiving the content and the related guide data at a device, wherein the device generates the content-centric electronic guide.

21. The machine-readable medium of claim 19, further comprising:
receiving an indication of favorite content of one or more viewers at the device, wherein generating the content-centric electronic guide is also based on the indication of favorite content.

22. The machine-readable medium of claim 21, further comprising:
displaying the content-centric electronic guide, wherein the displayed content-centric electronic guide lists the favorite content by relevance based on the indication of favorite content.

23. The machine-readable medium of claim 21, further comprising:
displaying the content-centric electronic guide, wherein the displayed content-centric electronic guide lists the favorite content in alphabetical order.

24. The machine-readable medium of claim 21, further comprising:
displaying the content-centric electronic guide, wherein the displayed content-centric electronic guide lists the favorite content for a specific viewer of the one or more viewers.

25. The machine-readable medium of claim 19, further comprising:
displaying the content-centric electronic guide; and
allowing the one or more viewers to change the format of the displayed content-centric electronic guide.

26. The machine-readable medium of claim 19, wherein the content and the related guide data may be received from one or more of a broadcast center server, the Internet, a local area network (LAN) and the device.

27. The machine-readable medium of claim 19, further comprising: receiving the content and the related guide data at a device, wherein the device generates the content-centric electronic guide and wherein the device is a set-top box.
